(19) United States
(12) Patent Application Publication
(10) Pub. No.: US 2024/0225111 A9
(43) Pub. Date: Jul. 11, 2024

(54) AEROSOL-GENERATING DEVICE WITH COMPARTMENT WALL

(71) Applicant: Philip Morris Products S.A., Neuchatel (CH)

(72) Inventors: Rui Nuno Rodrigues Alves BATISTA, Morges (CH); Valerio OLIANA, Pully (CH); Alexandra SEREDA, Neuchatel (CH); Gianluca BONGIOVANNI, Boudry (CH); Bekele Alemu BEDASSO, Neuchatel (CH)

(73) Assignee: Philip Morris Products S.A., Neuchatel (CH)

(21) Appl. No.: 18/546,033

(22) PCT Filed: Feb. 17, 2022
(86) PCT No.: PCT/EP2022/053905

§ 371 Date: Aug. 10, 2023

(30) Foreign Application Priority Data
Feb. 18, 2021 (EP) 21157763.0

(51) Int. Cl. A24F 40/465; A24F 7/02; A24F 40/10; A24F 40/20; A24F 40/30; A24F 40/42; A24F 40/485; H05B 6/10

(52) U.S. Cl. CPC A24F 40/465; A24F 7/02; A24F 40/10; A24F 40/20; A24F 40/30; A24F 40/42; A24F 40/485; H05B 6/108

(57) ABSTRACT

An aerosol-generating system is provided, including: an aerosol-generating device; a cartridge including a liquid agent, the cartridge being configured to be detachably connected to the aerosol-generating device; and an aerosol-generating article, the aerosol-generating device including a cavity configured to receive the aerosol-generating article including an aerosol-forming substrate, and a heating element configured to heat the aerosol-generating article received in the cavity, the heating element including a compartment wall, a first part of the compartment wall being located in the cavity and a second part of the compartment wall extending outside the cavity, and the second part of the compartment wall being configured to interact with the cartridge. A method of operating an aerosol-generating system is also provided.

The present invention relates to an aerosol-generating device comprising a compartment. The present invention further relates to a system for generating an aerosol including the aerosol-generating device, and one or both of an aerosol-generating article and a cartridge. The present invention further relates to a method of operating the aerosol-generating system for forming an aerosol.

Aerosol-generating devices are known which heat but which do not burn aerosol-forming substrates in aerosol-generating articles such as tobacco. Such devices heat the aerosol-forming substrates to a sufficiently high temperature for generating an aerosol for inhalation by the user. These aerosol-generating devices normally include a cavity for receiving the aerosol-forming substrates. These devices are typically portable, hand-held devices and are required to be compact. Other aerosol-generating devices are known, which generate an aerosol from a liquid aerosol-forming substrate. Connecting and detaching cartridges containing the liquid aerosol-forming substrate from the aerosol-generating devices often leads to spill over of the liquid due to leakages.

It would be desirable to provide an aerosol-generating device which can easily be connected and detached from a cartridge without the risk of leakage. It furthermore would be desirable to provide an aerosol-generating system which provides a user with the possibility to use different aerosol-forming substrates depending on preference. It would be desirable to provide an aerosol-generating device with the capability of aerosolizing different components of an aerosol at different temperatures.

According to an embodiment of the present invention an aerosol-generating device is provided which may comprise a cavity for receiving an aerosol-generating article comprising an aerosol-forming substrate. The aerosol-generating device may comprise a heating element being configured to heat the aerosol-generating article received in the cavity. The heating element may comprise a compartment wall. A first part of the compartment wall may be located in the cavity and a second part of the compartment wall may extend outside the cavity.

According to another embodiment of the present invention there is provided an aerosol-generating device comprising a cavity for receiving an aerosol-generating article comprising an aerosol-forming substrate. The aerosol-generating device is configured to heat the aerosol-generating article received in the cavity. The heating element of the aerosol-generating device comprises a compartment wall. A first part of the compartment wall is located in the cavity and a second part of the compartment wall extends outside the cavity.

The first part of the compartment wall located in the cavity may directly be heated by the heating element. The first part of the compartment wall may confine a first heating zone. The first heating zone may be configured for receiving the aerosol-generating article inside the cavity.

The compartment wall may have a tubular form. One or both of the first part of the compartment wall and the second part of the compartment wall may have a tubular form. The compartment wall may one of a circular, elliptical, rectangular or square cross section.

Heating the first part of the compartment may heat the aerosol-generating article received in the first heating zone in the cavity. In contrast to that, the second part of the compartment wall which may extend outside the cavity may not be directly heated by the heating element. The second part of the compartment wall may be configured to be indirectly heated by the heating element. The second part of the compartment wall may confine a second heating zone. The aerosol-generating device therefore may provide two different heating zones. A first heating zone confined by the first part of the compartment wall, which is heated directly by the heating element and a second heating zone confined by the second part of the compartment wall which is outside the cavity and which therefore is not directly heated by the heating element. Heat may be transferred from the first part of the compartment wall to the second part of the compartment wall outside the cavity via one or both of heat conduction through the material of the compartment wall and heat convection.

The second part of the compartment wall may be configured to interact with a cartridge containing a liquid agent. The second part of the compartment wall may be configured for being detachably connected to the cartridge comprising the liquid agent. The aerosol-generating device may be configured to be employed with an aerosol-generating article comprising an aerosol-forming substrate for forming an aerosol and with a cartridge containing a liquid agent. The liquid agent also may form part of the aerosol. The aerosol-generating device thus may be configured to generate an aerosol from different substrates, an aerosol-generating article and a liquid agent. Owing to the second part of the compartment wall, the cartridge may be detachably connected to the aerosol-generating device. This may allow the replacement of the cartridge, allowing the use of different cartridges with different liquid agents to be used with the aerosol-generating device.

The cartridge may be a replaceable cartridge being configured for being detachably connected to the aerosol-generating device. The cartridge may comprise a liquid storage portion for storing the liquid agent. The liquid storage portion may comprise a liquid outlet for directing the liquid agent out of the liquid storage portion. The cartridge may comprise a slidable sealing element for sealing the liquid outlet. The slidable sealing element may be configured to slide away from the liquid outlet upon application of a pressure to the sealing element. The pressure may be applied by the second part of the compartment wall of the aerosol-generating device upon connecting the cartridge with the aerosol-generating device. Thus, the interaction between the second part of the compartment wall of the aerosol-generating device and the slidable sealing element of the cartridge may allow liquid agent to exit the cartridge and contact the second part of the compartment wall. Further details of the cartridge and the other components of an aerosol-generating system comprising the aerosol-generating device, the cartridge and an aerosol-generating article will be described below in greater detail.

The second part of the compartment wall of the aerosol-generating device may extend downstream of the cavity. This may ensure, that the second part of the compartment wall is heated indirectly via heat convection resulting from the heated aerosol generated in the first part of the compartment. The first part of the compartment wall therefore would be located upstream of the second part of the compartment wall. Locating the second part of the compartment wall downstream of the cavity also may facilitate that any agents, in particular liquid agents provided in the second heating zone confined by the second part of the compartment wall can be entrained in an aerosol formed from the aerosol-generating article in the first heating zone.

As used herein, the terms “upstream”, and “downstream”, are used to describe the relative positions of components, or portions of components, of the aerosol-generating device in relation to the direction in which air flows through the aerosol-generating device during use thereof along the air flow path. Aerosol generating devices according to the invention comprise a proximal end through which, in use, an aerosol exits the device. The proximal end of the aerosol generating device may also be referred to as the mouth end or the downstream end. The mouth end is downstream of the distal end. The mouth end may comprise a mouthpiece. The distal end of the aerosol generating device may also be referred to as the upstream end. Components, or portions of components, of the aerosol generating device may be described as being upstream or downstream of one another based on their relative positions with respect to the airflow path through the aerosol generating device.

The first part of the compartment wall and the second part of the compartment wall may form one single continuous compartment wall. The compartment wall may comprise a tubular shape. This may ensure that any aerosol-generating article, in particular any tubular-shaped article can easily be received in the first heating zone.

The heating element of the aerosol-generating device may be configured to indirectly heat the second part of the compartment wall via one or both of heat conduction and heat convection. This may enable to heat the second part of the compartment wall in a reliable way. The first part of the compartment wall located in the cavity of the aerosol-generating device may be heated directly by the heating element. Thus, one heating element may allow the provision of two different heating zones in the aerosol-generating device due to the first and the second part of the compartment wall.

The second part of the compartment wall may comprise one or both of holes and at least one porous section. This may enable the second part of the compartment wall to accommodate a liquid agent from a cartridge. The porous section in the second part of the compartment wall may be configured to store any liquid agent. The porous section of the second part of the compartment wall may comprise a metal foam. The second part of the compartment wall may comprise holes, which can be generated in the second part of the compartment by any suitable means. For example, the holes in the second part of the compartment wall may be formed by drilling or by laser. The holes in the second part of the compartment wall may allow liquid agent released from the cartridge to enter the air flow path of the aerosol-generating device in order to be aerosolized. Likewise, porous parts of the second part of the compartment wall may store any liquid agent released from the cartridge until the liquid agent enters the airflow path of the aerosol-generating device in order to be aerosolized. The airflow path of the aerosol-generating device may pass through the second heating zone confined by the second part of the compartment wall of the heating element. The stored liquid agent may be aerosolized and may be included in an aerosol formed in the first part of the compartment in the cavity of the aerosol-generating device.

The second heating zone confined by the second part of the compartment wall may be hollow. This may allow the aerosol-generating article to be inserted through the second heating zone into the first heating zone confined by the first part of the compartment wall located in the cavity of the aerosol-generating device. The second zone may have a cross-sectional shape being the same as the cross-sectional shape of the first zone. In particular both the first part and the second part of the compartment wall may have a tubular shape. This may result in the same circular or elliptical cross-sectional shape of the first heating zone and of the second heating zone. This may allow a rod-shaped aerosol-generating article to be inserted into the first heating zone confined by the first part of the compartment wall through the second heating zone confined by the second part of the compartment wall. The second heating zone may have a cross-sectional shape being different to the cross-sectional shape of the first heating zone. For example, the second part of the compartment wall may comprise a cubic shape with two opposing sides being open, whereas the first part of the compartment wall may comprise a tubular shape. This may result in the cross-sectional shape of the second compartment wall being rectangular, whereas the cross-sectional shape of the first compartment wall may be circular or elliptical, depending on the tubular shape of the first part of the compartment wall. In this case the cross-sectional area of the second heating zone overlaying the cross-sectional area of the first heating zone may be as big or larger than the cross-sectional area of the first heating zone. This may allow the insertion of the aerosol-generating article into the first part of the compartment through the second part of the compartment, even if the first and second part of the compartment have different cross-sectional shapes.

The first part of the compartment wall and the second part of the compartment wall may be connected in a thermally conductive manner. This may facilitate the conduction of heat from the first part of the compartment wall to the second part of the compartment wall in a particular simple way. For example, there may be a thermally conductive connection comprising one or both of metal and a ceramic between the first part of the compartment wall and the second part of the compartment wall. This thermally conductive connection may ensure that any heat produced in the first part of the compartment wall is effectively transferred to the second part of the compartment wall via heat conduction. This may also allow to transfer any heat of the first heating zone to the second heating zone.

The first part of the compartment wall and the second part of the compartment wall may be made of the same material. This may ease the production of one single continuous compartment wall. This may also facilitate the conduction of heat from the first part of the compartment wall to the second part of the compartment wall. The first part of the compartment wall and the second part of the compartment wall may be formed as one-piece-member. This may allow the production of the first part of the compartment wall and the second part of the compartment wall by providing one piece of compartment wall. Additionally, this also may ease the heat conduction from the first part of the compartment wall to the second part of the compartment wall.

The compartment wall may comprise one or both of a metal and a ceramic. The compartment wall may comprise one or both of a ferromagnetic metal or a ferromagnetic ceramic. One or both of a metal and a ceramic may provide a good heat conduction between the first part of the compartment wall and the second part of the compartment wall. This may facilitate the indirect heating of the second part of the compartment wall via heat conduction from the first part of the compartment wall. Providing one or both of a ferromagnetic metal in the ferromagnetic ceramic furthermore may enable the heating of the compartment wall by inductive heating.

The heating element may comprise one or both of an inductive heating element and a resistive heating element. A resistive heating element may comprise a heating coil disposed around the first part of the compartment wall of the aerosol-generating device. The resistive heating element may comprise a resistive wire. The resistive wire may be wrapped around the first part of the compartment wall of the aerosol-generating device.

Suitable electrically resistive materials for the resistive heating element include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, nickel-, cobalt-, chromium-, aluminium- titanium- zirconium-, hafnium-, niobium-, molybdenum-, tantalum-, tungsten-, tin-, gallium-, manganese- and iron-containing alloys, and super-alloys based on nickel, iron, cobalt, stainless steel, Timetal® and iron-manganese-aluminium based alloys. In composite materials, the electrically resistive material may optionally be embedded in, encapsulated or coated with an insulating material or vice-versa, depending on the kinetics of energy transfer and the external physicochemical properties required. Examples of suitable composite heater elements are disclosed in U.S. Pat. No. 5,498,855, WO-A-03/095688 and U.S. Pat. No. 5,514,630. One preferred resistive heating material may be nickel chromium alloy.

Preferably, the heating element may be an inductive heating element. The heating element may preferably be an induction coil. The compartment wall may be a susceptor. The inductive heating element, preferably the induction coil may be configured for heating the first part of the compartment wall. The inductive heating element may be connected to a power supply. The inductor coil may be able to provide an inductance of between 1 micro Henry (μH) to 500 nano Henry (nH).

This may provide an efficient way for heating the first part of the compartment wall located in the cavity of the aerosol-generating device.

The induction coil may be configured for indirectly heating the second part of the compartment wall. Preferably the induction coil may be configured for indirectly heating the second part of the compartment wall via heat conduction from the first part of the compartment wall to the second part of the compartment wall. This may provide an aerosol-generating device comprising two different heating zones. A first heating zone may be provided confined by the first part of the compartment wall, which is directly heated by the heating element of the aerosol-generating device. A second heating zone may be provided confined by the second part of the compartment wall, which is indirectly heated via heat conduction from the first part of the compartment wall to the second part of the compartment wall. During operation of the aerosol-generating device the temperature in the first heating zone may be higher than the temperature in the second heating zone. Temperature at the first heating zone, confined by the first part of the compartment wall may be between 200 degrees Celsius and 350 degrees Celsius. The temperature at the second heating zone, confined by the second part of the compartment wall may be between 160 degrees Celsius and 220 degrees Celsius.

In general, the compartment wall comprises or is made of a material that is capable of generating heat, when penetrated by an alternating magnetic field. If the compartment wall is conductive, then typically eddy currents are induced by the alternating magnetic field. If the compartment wall is magnetic, then typically another effect that contributes to the heating is commonly referred to hysteresis losses. Hysteresis losses occur mainly due to the movement of the magnetic domain blocks within the material of the compartment wall, because the magnetic orientation of these will align with the magnetic induction field, which alternates. Another effect contributing to the hysteresis loss is when the magnetic domains will grow or shrink within the material of the compartment wall. Commonly all these changes in the material of the compartment wall that happen on a nano-scale or below are referred to as “hysteresis losses”, because they produce heat in the material of the compartment wall. Hence, if the susceptor is both magnetic and electrically conductive, both hysteresis losses and the generation of eddy currents will contribute to the heating of the compartment. If the material of the compartment wall is magnetic, but not conductive, then hysteresis losses will be the only means by which the susceptor will heat, when penetrated by an alternating magnetic field. According to the invention, the material of the compartment wall may be magnetic and electrically conductive. An alternating magnetic field generated by one or several induction coils heats the material of the first part of the compartment wall, which then transfer the heat to the second part of the compartment wall. The heat transfer may be mainly by conduction of heat. Additionally, the second heating zone may be heated via heat convection, when the heated aerosol generated in the first heating zone passes through the second heating zone. Preferably, the second part of the compartment wall and its second heating zone is indirectly heated by both, by heat conduction from the first part of the compartment wall to the second part of the compartment wall and via heat convection when the heated aerosol generated in the first heating zone passes through the second heating zone.

A preferred susceptor material for the compartment wall may comprise or consist of a ferromagnetic material, for example a ferromagnetic alloy, ferritic iron, or a ferromagnetic steel or stainless steel. A suitable susceptor may be, or comprise, aluminium. Preferred susceptors may be heated to a temperature in excess of 250 degrees Celsius.

Preferred susceptor material for the compartment wall are metal susceptors, for example stainless steel. However, susceptor materials may also comprise or be made of any one of graphite, molybdenum, silicon carbide, aluminum, niobium, Inconel alloys (austenite nickel-chromium-based superalloys), metallized films, ceramics such as for example zirconia, transition metals such as for example iron, cobalt, nickel, or metalloids components such as for example boron, carbon, silicon, phosphorus, aluminium, or combinations or alloys of materials.

The heating element may be located adjacent to the first part of the compartment wall. This may facilitate the heating of the first part of the compartment wall by the heating element. The heating element being an induction coil may be located adjacent to the first part of the compartment wall. The induction coil may at least partly surround the first part of the compartment wall. This may ease the heating of the first part of the compartment wall by the induction coil via inductive heating.

The aerosol-generating device may comprise at least one air inlet. The at least one air inlet may allow air from the outside to enter the aerosol-generating device. The at least one air inlet may be configured to allow air to enter the cavity and the first and second heating zone. In particular, the at least one air inlet may be configured to allow air to enter the first heating zone confined by the first part of the compartment wall being located in the cavity. This may allow air to enter the cavity and the first heating zone for aerosol generation resulting from the aerosol-forming substrate included in the aerosol-generating article.

The aerosol-generating device may comprise an airflow path. The at least one air inlet may be located at the upstream end of the airflow path. The airflow path may lead from the at least one air inlet through the first heating zone located in the cavity into the second heating zone. This may allow an aerosol generated from the aerosol-generating article in the first heating zone to be transferred to the second heating zone. Any liquid agent from the cartridge present in the second part of the compartment wall may then be entrained in the aerosol.

The aerosol-generating device may comprise electric circuitry. The electric circuitry may comprise a microprocessor, which may be a programmable microprocessor. The microprocessor may be part of a controller. The electric circuitry may comprise further electronic components. The electric circuitry may be configured to regulate a supply of power to the heating element, particularly to the induction coil. Power may be supplied to the heating element continuously following activation of the aerosol-generating device or may be supplied intermittently, such as on a puff-by-puff basis. The power may be supplied to the heating element in the form of pulses of electrical current. The electric circuitry may be configured to monitor the electrical resistance of the heating element, and preferably to control the supply of power to the heating element dependent on the electrical resistance of the heating element.

The aerosol-generating device may comprise a power supply, typically a battery, within a main body of the aerosol-generating device. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery. As an alternative, the power supply may be another form of charge storage device such as a capacitor. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the heating element.

The invention also provides an aerosol-generating system, which may comprise an aerosol-generating device as described herein and one or both of a cartridge comprising a liquid agent, the cartridge being configured for being detachably connected to the aerosol-generating device and an aerosol-generating article.

In another embodiment the invention provides an aerosol-generating system, which comprises an aerosol-generating device as described herein and one or both of a cartridge comprising a liquid agent, the cartridge being configured for being detachably connected to the aerosol-generating device and an aerosol-generating article.

The aerosol-generating article may be received in the first heating zone confined by the first part of the compartment located in the cavity of the aerosol-generating device.

As used herein, the term ‘aerosol-generating article’ refers to an article comprising an aerosol-forming substrate that is capable of releasing volatile compounds that can form an aerosol. For example, an aerosol-generating article may be a smoking article that generates an aerosol that is directly inhalable into a user's lungs through the user's mouth. An aerosol-generating article may be disposable. The cavity of the aerosol-generating device may have an open end into which the aerosol-generating article is inserted. The open end may be a proximal end. The cavity may have a closed end opposite the open end. The closed end may be the base of the cavity. The closed end may be closed except for the provision of air apertures arranged in the base. The base of the cavity may be flat. The base of the cavity may be circular. The base of the cavity may be arranged upstream of the cavity. The open end may be arranged downstream of the cavity. The cavity may have an elongate extension. The cavity may have a longitudinal central axis. A longitudinal direction may be the direction extending between the open and closed ends along the longitudinal central axis. The longitudinal central axis of the cavity may be parallel to the longitudinal axis of the aerosol-generating device.

The cavity may have a cylindrical shape. The cavity may have a hollow cylindrical shape. The cavity may have a shape corresponding complimentary to the shape of the aerosol-generating article to be received in the cavity. The cavity may be shaped to contain the aerosol-generating article. The cavity may have a circular cross-section. The cavity may have an elliptical or rectangular cross-section.

The aerosol-generating article may comprise aerosol-forming substrate.

As used herein, the term ‘aerosol-forming substrate’ relates to a substrate capable of releasing one or more volatile compounds that can form an aerosol. Such volatile compounds may be released by heating the aerosol-forming substrate. An aerosol-forming substrate may conveniently be part of an aerosol-generating article or smoking article. The aerosol-forming substrate may be part of a substrate portion of the aerosol-generating article.

The aerosol-forming substrate may be a solid aerosol-forming substrate. The aerosol-forming substrate may comprise both solid and liquid components. The aerosol-forming substrate may comprise a tobacco-containing material containing volatile tobacco flavour compounds which are released from the substrate upon heating. The aerosol-forming substrate may comprise a non-tobacco material. The aerosol-forming substrate may comprise an aerosol former that facilitates the formation of a dense and stable aerosol. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetra-decanedioate. Aerosol formers may be polyhydric alcohols or mixtures thereof, such as triethylene glycol, 1,3-butanediol and glycerine. The aerosol-former may be propylene glycol. The aerosol former may comprise both glycerine and propylene glycol. The aerosol-forming substrate also may comprise a susceptor material for inductive heating of the substrate.

The cartridge may comprise a liquid storage portion for storing a liquid agent. The liquid storage portion may comprise a liquid outlet for directing liquid agent out of the liquid storage portion. The cartridge may comprise a slidable sealing element for sealing the liquid outlet. Sealing means that the liquid contained in the liquid storage portion is sufficiently prevented from leaving the liquid storage portion so that drops of liquid are not produced in and around the liquid outlet of the cartridge. Sealing means that liquid is prevented from collecting at the connection point between the cartridge and the device. The slidable sealing element may be configured so that when not engaged with the aerosol-generating device, the slidable sealing element seals the liquid outlet. When the cartridge is engaged with the aerosol-generating device, the slidable sealing element slides away from the liquid outlet to allow liquid agent to flow through the liquid outlet to reach a porous material, located in the aerosol-generating article. The slidable sealing element may be pushed away from the second part of the compartment wall of the aerosol-generating device when the cartridge is connected to the aerosol-generating device. The slidable sealing element may slide to re-seal the liquid outlet when the cartridge is removed from the aerosol-generating device. Because the slidable sealing element seals the liquid outlet when the cartridge is not engaged with the aerosol-generating device, the slidable sealing element reduces the risk of leakage when a cartridge is not engaged with the aerosol-generating device.

The cartridge may comprise a flexible biasing member. The flexible biasing member may be configured for holding the sealing member in a position sealing the liquid outlet, when no pressure is applied to the sealing member and the cartridge is not connected to the aerosol-generating device, in particular the second part of the compartment. The flexible biasing member may furthermore allow the slidable sealing member to slide away from the liquid outlet in order to enable the release of the liquid agent, when pressure is applied to the sealing member. This may happen when the cartridge is being connected to the aerosol-generating device. The flexible biasing member furthermore may be configured to slide the slidable sealing member back to a position sealing the liquid outlet, if the pressure ceases to be applied. The flexible biasing member may be spring or any other biasing member suitable for maintaining the slidable sealing member in a position sealing the liquid outlet.

The liquid agent may comprise one or more of flavorants, nicotine and medications. For example, the one or more active agents may comprise flavorants oils, such as mint oil, menthol, nicotine oil or other flavorants. The liquid agent also might comprise a carrier liquid for dissolving any liquid agent. The carrier liquid may be one or more of polyhydric alcohols, such as propylene glycol, glycerol, and water.

The replaceable cartridge also may comprise a central hollow portion. The liquid outlet may be configured to direct any liquid agent from the liquid storage portion into the central hollow portion of the cartridge. Any liquid agent in the central hollow portion may be entrained in the aerosol and may transferred further downstream in the aerosol.

The slidable sealing element of the cartridge may be located in the central hollow portion closing the liquid outlet, when the cartridge is not connected to the aerosol-generating device. The slidable sealing element may be configured to slide away from the liquid outlet upon coming in contact with the second part of the compartment of the aerosol-generating device. Upon connecting the cartridge with the aerosol-generating device, the second part of the compartment wall of the aerosol-generating device may be received in the central hollow portion of the cartridge. Furthermore, the second part of the compartment wall may push the slidable sealing element from the liquid outlet, thereby opening the liquid outlet. Any liquid agent exiting the cartridge through the liquid outlet may then be received by the second part of the compartment wall in the second heating zone of the aerosol-generating device. The liquid agent received by the second part of the compartment wall may be entrained in the aerosol generated from the aerosol-generating article received in the first heating zone confined by the first part of the compartment in the cavity of the aerosol-generating device. Any liquid agent received by the second part of the compartment wall may be heated by one or both of heat conduction and heat convection. Heating via heat conduction may be facilitated by the conduction of heat from the sidewalls of the first part of the compartment wall to the sidewalls of the second part of the compartment wall. This may be accomplished in a particularly easy way when the first part and the second part of the compartment wall are connected in a thermally conductive manner. Furthermore, heating via heat conduction is greatly facilitated when the sidewalls of the first part and the second part of the compartment wall comprises thermally conductive material, such as metal, ceramics or any combination thereof. Heating the liquid agent received by the second part of the compartment wall in the second heating zone may greatly facilitate that the liquid agent is entrained in the aerosol.

The sealing element may be ring-shaped. The sealing element may form a sealing ring. The cartridge may comprise an annular shape. The central hollow portion may have a tubular shape. A ring-shaped sealing element may be particularly well suited in order to seal one or more liquid outlets located at the wall of a tubular shaped central hollow portion. Such a ring-shaped sealing element may have any shape. The shape of the ring-shaped sealing element depends on the shape of the parts meant to be sealed. The sealing ring may be, for example, rectangular, ovoid, annular, a cap, or may have a complicated shape. The sealing ring may be made of any material suitable for sealing two parts together.

More than one liquid outlet may be present in the cartridge. In particular, at least two liquid outlets, at least three or at least four liquid outlets may be present in the cartridge. These liquid outlets may be arranged along the inner walls of the annular-shaped cartridge. One sealing element may be configured to seal said plurality of liquid outlets by the way of a ring-shaped sealing element sealing some or all liquid outlets at the same time.

The aerosol-generating system furthermore may comprise a mouthpiece. The mouthpiece may be configured to be detachably connected to one or both of the cartridge and the aerosol-generating device. The mouthpiece may be configured to be detachably connected to one or both of the cartridge and the aerosol-generating device being spaced apart from the second part of the compartment wall of the aerosol-generating device. This may create an internal hollow space in the aerosol-generating system, in particular an internal hollow space in the central hollow portion of the cartridge, which may allow the mixing of the different components of the aerosol. This internal hollow space may enable efficient mixing of the aerosol generated in the first heating zone from the aerosol-generating article with the liquid agent received in the second part of the compartment wall in the second heating zone. A user may directly draw on the mouthpiece. The mouthpiece therefore may be located at the downstream end of the aerosol-generating system

The aerosol-generating system may include an air flow path through the system. At least one air inlet provided in the aerosol-generating device may be the upstream end of the air flow path through the aerosol-generating system. The at least one air inlet may allow ambient air to enter the aerosol-generating device, in particular the first heating zone in the cavity of the aerosol-generating device. The airflow path may pass through the first heating zone through the second zone and into the internal hollow space of the central hollow portion of the cartridge. The downstream end of the air flow path may be the mouthpiece on which a user may draw in order to inhale the aerosol. Directing the airflow path through the first heating zone and the second heating zone towards the internal hollow space may enable an efficient mixing of the aerosol generated in the first heating zone from the aerosol-generating article with the liquid agent received in the second heating zone.

The invention also provides a method of operating the aerosol-generating system described herein. The method may comprise the method steps of:
receiving the aerosol-generating article in the first hearting zone confined by the first part of the compartment in the cavity of the aerosol-generating device,
connecting the cartridge to the aerosol-generating device, the second part of the compartment wall pushing the slidable sealing element away from the liquid outlet, so that liquid agent contacts the second part of the compartment wall which confines a second heating zone,
heating the aerosol-generating article, thereby generating an aerosol from the aerosol-generating article and the liquid agent.

This method of operating the aerosol-generating system allows the generation of an aerosol from the aerosol-generating article and from the liquid agent contained in the cartridge. The liquid agent may be used in order to supplement the aerosol generated from the aerosol-generating article with one or more of nicotine and flavors.

The aerosol-generating article used in the method of operating may comprise a solid aerosol-forming substrate. Such a method may allow the generation of an aerosol from a solid substrate of the aerosol-generating article and from the liquid agent.

During operation, the heating element of the aerosol-generating device may heat the first part of the compartment wall in the cavity which has received the aerosol-generating article. In particular, the first part of the compartment wall may be a susceptor and the heating element may comprise an inductive coil, inducing a variable magnetic field in the susceptor, thereby heating up the susceptor. The heating element of the aerosol-generating device may therefore directly heat the first part of the compartment wall.

The second part of the compartment wall may be heated indirectly via heat conduction. In particular heat may be transferred from the heated first part of the compartment wall to the second part of the compartment wall. The first part of the compartment wall and the second part of the compartment wall may be connected in a thermally conductive manner. The first part of the compartment wall and the second part of the compartment wall may be made or may comprise thermally conductive materials. The temperature in the first part of the compartment, which is directly heated may be larger than the temperature in the second part of the compartment, which is indirectly heated.

The second part of the compartment also may be indirectly heated via heat convection from the first part of the compartment wall. The heated aerosol generated in the first heating zone may flow through the second heating zone, also heating the second part of the compartment wall. This may facilitate the generation of an aerosol also including the liquid agent received in the second part of the compartment wall.

The method of operating the aerosol-generating system may also comprise the additional method step of detaching the cartridge from the aerosol-generating device, the sealing element sliding over the liquid outlet, thereby sealing the liquid outlet.

Such a method step may ensure that the cartridge containing the liquid agent can easily be connected and detached from the aerosol-generating device without the risk of a spill over of the liquid agent.

A biasing member, for example a spring may enable the sliding of the sealing element over the liquid outlet, when the cartridge is detached from the aerosol-generating device.

The aerosol-generating device may have a length of between 100 millimeters to 150 millimeters, preferably of 100 millimeters to 120 millimeters. The cartridge may have a length of between 20 millimeters to 40 millimeters, preferably 25 millimeters to 30 millimeters. The cartridge may have a width of 20 millimeters to 40 millimeters, preferably 25 millimeters to 30 millimeters. The heating element of the aerosol-generating device may have a length of between 7 millimeters to 14 millimeters, preferably of between 3 millimeters to 5 millimeters. The heating element of the aerosol-generating device may have a diameter of 6 millimeters to 12 millimeters, preferably of 10 millimeters to 12 millimeters. The central hollow portion of the cartridge may have a diameter of between 10 millimeters to 15 millimeters, preferably 10 millimeters to 12 millimeters. A resistive heating element formed as a resistive heating wire may have a diameter of between 0.2 millimeters to 0.5 millimeters, preferably 0.2 millimeters to 0.3 millimeters. The cavity within the aerosol-generating device may have a diameter between 50 millimeters to 70 millimeters, preferably 50 millimeters to 55 millimeters. The cavity may have a width of between 25 millimeters to 30 millimeters, preferably 25 millimeters to 28 millimeters. The slidable sealing element may have a length of between 6 millimeters to 8 millimeters, preferably 7 millimeters 28 millimeters. The slidable sealing element may be ring-shaped and may have a diameter of between 10 millimeters to 15 millimeters, preferably 10 millimeters to 12 millimeters. The first part of the compartment may have a diameter between 3 millimeters to 8 millimeters, preferably between 3 millimeters to 5 millimeters. The first part of the compartment may have a length of between 56 millimeters to 73 millimeters, preferably between 60 millimeters to 70 millimeters. The second part of the compartment may have a diameter between 3 millimeters to 8 millimeters, preferably between 3 millimeters to 5 millimeters. The second part of the compartment may have a length of between 4 millimeters to 6 millimeters, preferably between 4 millimeters to 5 millimeters.

Below, there is provided a non-exhaustive list of non-limiting examples. Any one or more of the features of these examples may be combined with any one or more features of another example, embodiment, or aspect described herein.

Example A: Aerosol-generating device comprising:
a cavity for receiving an aerosol-generating article comprising an aerosol-forming substrate, and
a heating element being configured to heat the aerosol-generating article received in the cavity, the heating element comprising a compartment wall, wherein a first part of the compartment wall is located in the cavity and wherein a second part of the compartment wall extends outside the cavity.

Example B: The aerosol-generating device according to Example A, wherein the second part of the compartment wall extends downstream of the cavity.

Example C: The aerosol-generating device according to any of the preceding examples, wherein first part of the compartment wall confines a first heating zone, the first heating zone configured for receiving the aerosol-generating article inside the cavity.

Example D: The aerosol-generating device according to the preceding example, wherein the second part of the compartment wall confines a second heating zone, preferably wherein the second part of the compartment wall comprises one or both of holes and at least one porous section.

Example E: The aerosol-generating device according to any of the preceding Examples C or D, wherein the compartment wall comprises one or both of a metal and a ceramic, preferably a ferromagnetic metal or a ferromagnetic ceramic.

Example F: The aerosol-generating device according to any of the preceding examples, wherein the heating element is an inductive heating element, preferably wherein the heating element comprises an induction coil, more preferably wherein the compartment wall is a susceptor, most preferably wherein the induction coil is configured for heating the first part of the compartment wall.

Example G: The aerosol-generating device according to the preceding Example F, wherein the induction coil is located adjacent to the first part of the compartment wall, preferably wherein the induction coil at least partly surrounds the first part of the compartment wall.

Example H: The aerosol-generating device according to any of the preceding Example F or G, wherein the induction coil is configured for indirectly heating the second part of the compartment wall, preferably wherein the induction coil is configured for indirectly heating the second part of the compartment wall via heat conduction from the first part of the compartment wall to the second part of the compartment wall.

Example I: The aerosol-generating device according to any of the preceding examples, wherein the first of the compartment wall and the second part of the compartment wall are made of the same material, preferably wherein the first part of the compartment wall and the second part of the compartment wall are formed as a one-piece member.

Example J: The aerosol-generating device according to any of the preceding examples, wherein the first part of the compartment wall and the second part of the compartment wall are connected in a thermally conductive manner.

Example K: The aerosol-generating device according to any of the preceding examples, wherein the second part of the compartment wall is configured for being detachably connected to a cartridge comprising a liquid agent.

Example L: The aerosol-generating device according to any of the preceding examples, wherein the first part of the compartment wall confines a first heating zone, the first heating zone is configured for receiving the aerosol-generating article inside the cavity.

Example M: Aerosol-generating system, comprising an aerosol-generating device according to any one of the preceding examples and one or both of a cartridge comprising a liquid agent, the cartridge being configured for being detachably connected to the aerosol-generating device and an aerosol-generating article.

Example N: The aerosol-generating system according to claim Example M, wherein the cartridge comprises a slidable sealing element and a liquid outlet for directing the liquid agent out of the cartridge, wherein the slidable sealing element is configured for sealing the liquid outlet when the cartridge is not connected to the aerosol-generating device.

Example O: The aerosol-generating system according to any of the Examples M or N, wherein the aerosol-generating system comprises a mouthpiece, wherein the mouthpiece is configured for being detachably connected to one or both of the cartridge and the aerosol-generating device, preferably wherein the mouthpiece is configured for being detachably connected to one or both of the cartridge and the aerosol-generating device being spaced apart from the second part of the compartment.

Example P: A method of operating an aerosol-generating system according to any one of the Examples M to O, comprising the method steps of:
receiving the aerosol-generating article in a first heating zone confined by the first part of the compartment in the cavity of the aerosol-generating device,
connecting the cartridge to the aerosol-generating device, the second part of the compartment wall pushing the slidable sealing element away from the liquid outlet, so that liquid agent contacts the second part of the compartment wall, the second part of the compartment wall confining a second heating zone,
heating the aerosol-generating article, thereby generating an aerosol from the aerosol-generating article and the liquid agent.

Example Q: The method of operating an aerosol-generating system according to the preceding Example P: wherein the aerosol-generating article comprises a solid aerosol-forming substrate, thereby generating an aerosol from the aerosol-generating article and the liquid agent.

Example R: The method of operating an aerosol-generating system according to the preceding Examples P or Q, wherein the heating element heats the first heating zone, preferably wherein the second heating zone is heated indirectly via heat conduction.

Example S: The method of operating an aerosol-generating system according to any one of the Examples P to R comprising the additional method step of:
detaching the cartridge from the aerosol-generating device, the sealing element sliding over the liquid outlet, thereby sealing the liquid outlet.

Features described in relation to one embodiment may equally be applied to other embodiments of the invention.

The invention will be further described, by way of example only, with reference to the accompanying drawings in which:

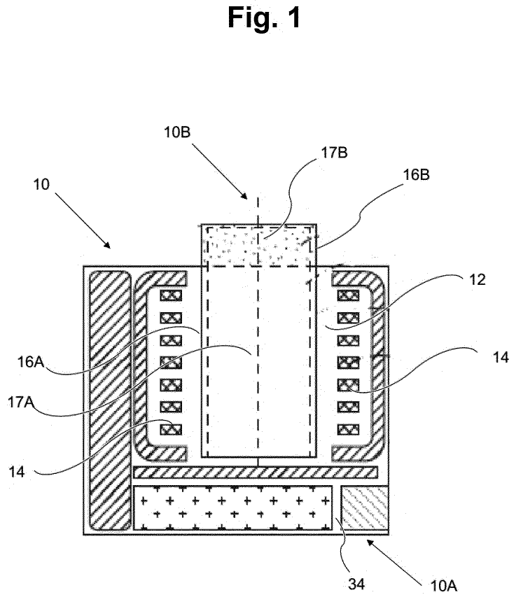

FIG. 1 shows a cross-sectional view of an aerosol-generating device with the compartment and an inductive coil as a heating element;

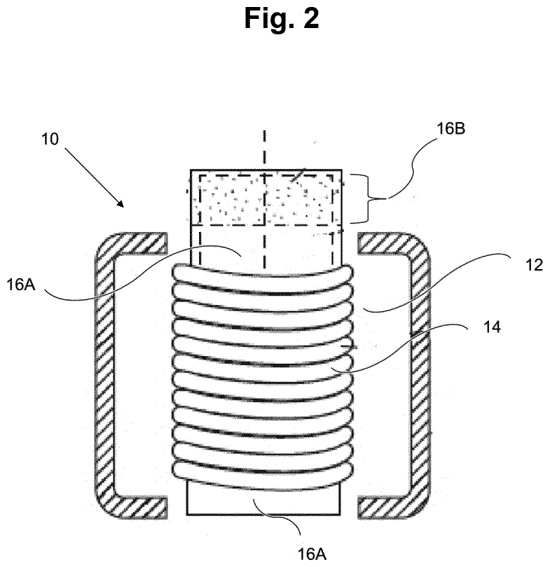

FIG. 2 shows a cross-sectional view of a different embodiment of an aerosol-generating device with a compartment and a resistive wire as a heating element;

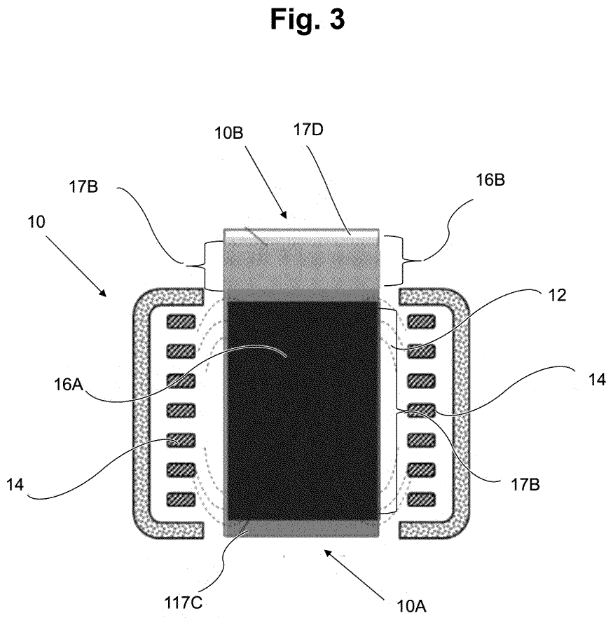

FIG. 3 depicts a schematic drawing of the heat distribution within the compartment of the aerosol-generating device;

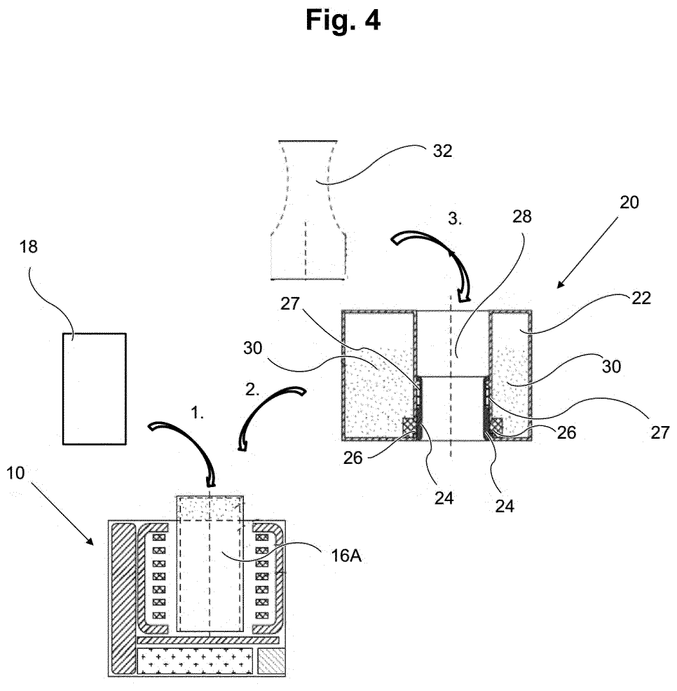

FIG. 4 depicts a schematic drawing of a way of assembling an aerosol-generating system comprising the aerosol-generating device, an aerosol-generating article, a cartridge and a mouthpiece;

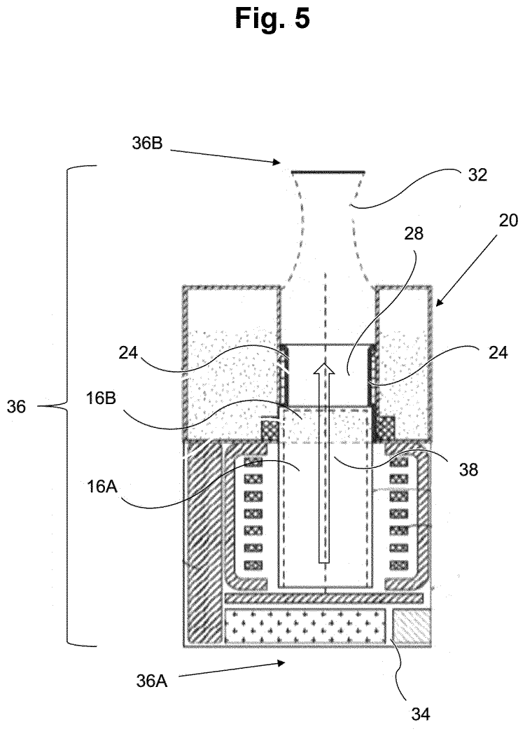

FIG. 5 depicts a cross-sectional view of a completely assembled aerosol-generating system comprising the aerosol-generating device of the present invention.

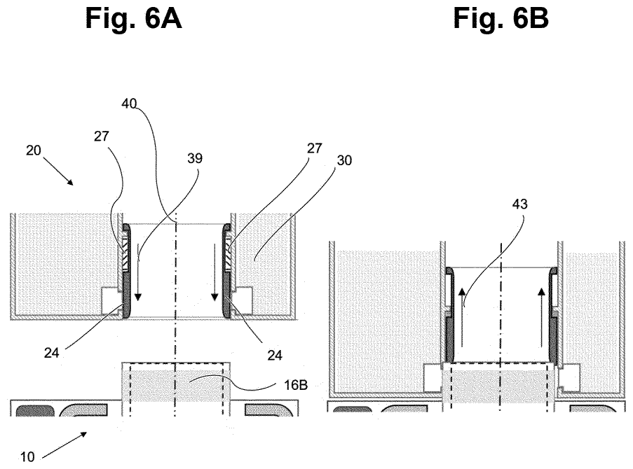

FIGS. 6A and 6B depict cut-out close-ups of the cartridge and the aerosol-forming device before they are connected (FIG. 6A) and after they have been connected (FIG. 6B), and

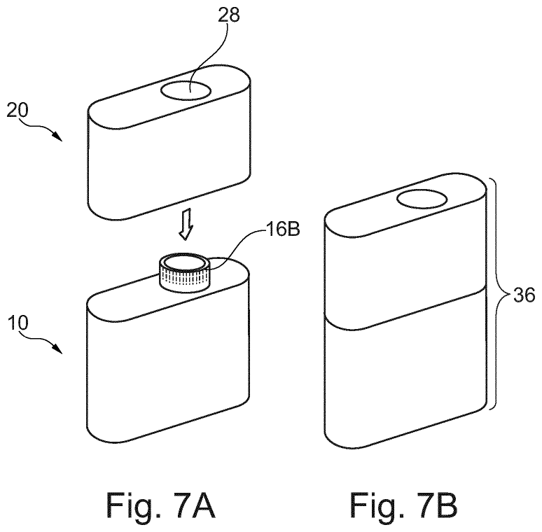

FIG. 7 a and FIG. 7B depict schematic perspective drawings of the cartridge and the aerosol-forming device before they are connected (FIG. 7A) and after they have been connected (FIG. 7B). In the following the same elements are marked with the same reference numerals throughout all the figures.

FIG. 1 shows a cross-sectional view of an aerosol-generating device 10 including a compartment. The aerosol-generating device 10 includes a heating element 14, an inductive coil adjacent to the first part 16A of a compartment wall located in the cavity 12 of the aerosol-generating device 10. Furthermore, an air inlet 34 is present at the upstream end 10A of the device, which allows ambient air to enter first part of the compartment located in the cavity 12 of the aerosol-generating device. The air may leave the aerosol-generating device at the downstream end 10B of the device. The first part 16A of the compartment wall is in direct contact with the second part 16B of the compartment wall, which extends outside the cavity 12 of the aerosol-generating device. The first part 16A and the second part 16B of the compartment wall can for example be made of one or both of metal or ceramic. Particularly preferred are paramagnetic metal or paramagnetic ceramic which can serve as susceptors for the inductive coil 14. The inductive coil 14 can directly heat the first part 16A of the compartment by introducing an alternating magnetic field. The first part 16A of the compartment wall confines a first heating zone 17A and the second part 16B of the compartment wall confines a second heating zone 17B. Heat from the first part 16A of the compartment wall may be transferred via heat conduction to the second part 16B of the compartment wall. Likewise, any heated aerosol generated in first heating zone 17A confined by the first part 16A of the compartment passing through the second part 16B of the compartment wall may also heat the second heating zone 17B. The aerosol-generating device 10 therefore enables the provision of different heating zones with one heating element within an aerosol-generating device which can be employed in order to aerosolize different components of an aerosol in an easy way.

FIG. 2 shows a cross-sectional view of a different embodiment of an aerosol-generating device. In contrast to the device shown in FIG. 1, the device of FIG. 2 includes a resistive heating wire 14, which is wrapped around the first part 16A of the compartment wall.

FIG. 3 depicts a schematic drawing of the different possible temperature zones within an aerosol-generating device 10. A first temperature zone 17A is confined by the first part 16A of the compartment wall and a second temperature zone 17B is confined by the second part 16B of the compartment wall. Owing to the direct heating by the inductive coil 14, the temperature in the first temperature zone 17A is higher than the temperature in the second temperature zone 17B, which is indirectly heated via heat conduction and heat convection from the first part 16A of the compartment wall. Directly adjacent to the first temperature zone 17A, a third temperature zone 17C is located at the upstream end 10A of the device, which has a lower temperature compared to the first temperature zone, due to cooling from outside air entering the aerosol-generating device via an air Inlet. Similarly, a fourth temperature zone 17D is located at the downstream end 10B of the device due to increased heat dissipation to the environment.

FIG. 4 depicts schematically a process for assembling an aerosol-generating system comprising an aerosol-generating article 18, the aerosol-generating device 10, a cartridge 20 including liquid agent 30 and finally a mouthpiece 32. In a first step (indicated by the arrow denoted with “1.”) an aerosol-generating article 18 is inserted into the first heating zone confined by the first part 16A of the compartment wall of the aerosol-generating device 10 through the hollow second heating zone confined by the second part 16B of the compartment wall. In a second step (indicated by the arrow denoted with “2.”) a cartridge 20 is attached to the aerosol-generating device 10. The cartridge 20 includes a liquid storage portion 22, which houses liquid agent 30. Liquid outlets 26 are present, which can direct the liquid agent 30 into the central hollow portion 28 of the cartridge 20. The liquid outlets 26 are covered by the slidable sealing element 24, which abuts the liquid outlet 26, thereby closing the liquid outlets. Biasing members 27, springs are present, which keep the slidable sealing element 24 over the liquid outlets 26, if the cartridge 20 is not connected to an aerosol-generating device. When connecting the cartridge 20 to the aerosol-generating device 10, the second part 16B of the compartment wall of the heating element pushes the sealing elements 24 away from the liquid outlets 26, thereby enabling the liquid agent 30 to be received by the second part of the compartment wall. In a third step (indicated by the arrow denoted with “3.”) a mouthpiece 32 can be connected to the downstream end of the system and to the cartridge 20. This process can be employed in order to assemble an aerosol-generating system, which can use to different substrates, the solid aerosol-generating article 18 and the liquid agent 30 from the cartridge 20 in order to generate an aerosol.

FIG. 5 depicts a cross-sectional view of an aerosol-generating system 36, including an aerosol-generating device 10, an aerosol-generating article (not shown in this Fig.), a cartridge 20 and a mouthpiece 32. Air can enter the first part 16A of the compartment of the aerosol-generating device 10 via an air inlet 34 located at the upstream end 36A of the aerosol-generating system. Upon heating of the first part 16A of the compartment surrounding the first temperature zone with the inductive coil 14, an aerosol can be generated from the aerosol-generating article received within the first part of the compartment wall. The air flow path through the aerosol-generating system 36 is indicated by the arrow denoted with the reference numeral 38. The aerosol generated in the first temperature zone passes through second temperature zone defined by the second part 16B of the compartment wall, so that any liquid agent received by this second part of the compartment wall can be entrained in the aerosol. Mixing of the components of the aerosol can take place in the internal hollow space provided by the central hollow portion 28 of the cartridge. The aerosol then may exit the downstream end 36B of the system through a mouthpiece 32.

FIG. 6A shows a cut-out close-up of the cartridge 20 and the aerosol-forming device 10 before they are connected. A flexible biasing element 27, for example a spring applies force to the slidable sealing element 24, so that the slidable sealing element is pushed in front of the liquid outlet 26 for sealing. The arrow 39 indicates the direction of the force applied to the slidable sealing element by the flexible biasing element for sealing the liquid outlet 26. The circumference of the central hollow portion 28 of the cartridge 20 corresponds to the circumference of the second part 16B of the compartment wall of the aerosol-forming device 10. This allows the second part 16B of the compartment wall to be inserted into the central hollow portion 28 of the cartridge.

FIG. 6B depicts the cartridge and the aerosol-forming device after they have been connected. The second part 16B of the compartment wall is pushed into the central hollow portion 28 of the cartridge, thereby pushing the slidable sealing element 24 along the direction of the arrow 43. This enables the liquid agent 30 to contact the second part 16B of the compartment via the wicking element 50, which comprises absorbent material for directing the liquid agent outside the cartridge to the second part of the compartment wall.

FIG. 7A shows a schematic perspective view of a flat cartridge 20 with a central hollow portion 28 and an aerosol-forming device 10 before they are connected. The annular shaped second part 16B of the compartment wall protrudes from the aerosol-forming device 10 and can be inserted into the central hollow portion 28 of the cartridge as indicated by the arrow.

FIG. 7B shows a schematic perspective view of the aerosol-generating system 36 after the cartridge 20 and the aerosol-forming device 10 have been connected.

1.-14. (canceled)

15. An aerosol-generating system, comprising:
an aerosol-generating device;
a cartridge comprising a liquid agent, the cartridge being configured to be detachably connected to the aerosol-generating device; and
an aerosol-generating article,
wherein the aerosol-generating device comprises:
a cavity configured to receive the aerosol-generating article comprising an aerosol-forming substrate, and
a heating element configured to heat the aerosol-generating article received in the cavity, the heating element comprising a compartment wall, wherein a first part of the compartment wall is located in the cavity and a second part of the compartment wall extends outside the cavity, and wherein the second part of the compartment wall is configured to interact with the cartridge.

16. The aerosol-generating system according to claim 15, wherein the second part of the compartment wall extends downstream of the cavity.

17. The aerosol-generating system according to claim 15, wherein the heating element is further configured to indirectly heat the second part of the compartment wall via one or both of heat conduction and heat convection.

18. The aerosol-generating system according to claim 15, wherein the first part of the compartment wall confines a first heating zone, the first heating zone being configured to receive the aerosol-generating article inside the cavity.

19. The aerosol-generating system according to claim 18, wherein the second part of the compartment wall confines a second heating zone.

20. The aerosol-generating system according to claim 18, wherein the second part of the compartment wall comprises one or both of holes and at least one porous section.

21. The aerosol-generating system according to claim 15, wherein the heating element is an inductive heating element.

22. The aerosol-generating system according to claim 15, wherein the heating element comprises an induction coil.

23. The aerosol-generating system according to claim 15, wherein the compartment wall is a susceptor.

24. The aerosol-generating system according to claim 22, wherein the induction coil is configured to heat the first part of the compartment wall.

25. The aerosol-generating system according to claim 22, wherein the induction coil is configured to indirectly heat the second part of the compartment wall.

26. The aerosol-generating system according to claim 22, wherein the induction coil is configured to indirectly heat the second part of the compartment wall via heat conduction from the first part of the compartment wall to the second part of the compartment wall.

27. The aerosol-generating system according to claim 15, wherein the first of the compartment wall and the second part of the compartment wall are made of the same material.

28. The aerosol-generating system according to claim 15, wherein the first part of the compartment wall and the second part of the compartment wall are formed as a one-piece member.

29. The aerosol-generating system according to claim 15, wherein the first part of the compartment wall and the second part of the compartment wall are connected in a thermally conductive manner.

30. The aerosol-generating system according to claim 15, wherein the first part of the compartment wall is configured to receive the aerosol-generating article inside the cavity.

31. The aerosol-generating system according to claim 15,
wherein the cartridge further comprises a slidable sealing element and a liquid outlet configured to direct the liquid agent out of the cartridge, and
wherein the slidable sealing element is configured to seal the liquid outlet when the cartridge is not connected to the aerosol-generating device.

32. The aerosol-generating system according to claim 15, further comprising a mouthpiece configured to be detachably connected to one or both of the cartridge and the aerosol-generating device.

33. The aerosol-generating system according to claim 15, further comprising a mouthpiece configured to be detachably connected to one or both of the cartridge and the aerosol-generating device being spaced apart from the second part of the compartment.

34. A method of operating an aerosol-generating system according to claim 15, the method comprising steps of:
receiving the aerosol-generating article in the first part of the compartment wall in the cavity of the aerosol-generating device;
connecting the cartridge to the aerosol-generating device, the second part of the compartment wall pushing the slidable sealing element away from the liquid outlet, so that liquid agent contacts the second part of the compartment wall; and
heating the aerosol-generating article, thereby generating an aerosol from the aerosol-generating article and the liquid agent.

35. The method according to claim 34, wherein the heating element heats the first part of the compartment wall.

36. The method according to claim 34, wherein the second part of the compartment wall is heated indirectly via one or both of heat conduction and heat convection.
